(19) United States
(12) Patent Application Publication
(10) Pub. No.: US 2025/0178604 A1
(43) Pub. Date: Jun. 5, 2025

(54) APPARATUS FOR RECOGNIZING AN OBJECT AND A METHOD THEREOF

(71) Applicants: HYUNDAI MOTOR COMPANY, Seoul (KR); KIA CORPORATION, Seoul (KR)

(72) Inventor: Bo Young Yun, Namyangju-si (KR)

(73) Assignees: HYUNDAI MOTOR COMPANY, Seoul (KR); KIA CORPORATION, Seoul (KR)

(21) Appl. No.: 18/749,868

(22) Filed: Jun. 21, 2024

(30) Foreign Application Priority Data
Dec. 5, 2023 (KR) 10-2023-0174674

(51) Int. Cl. B60W 30/095; G01S 13/86; G01S 17/931; G06T 7/292; G06T 7/30; G06V 20/58

(52) U.S. Cl. CPC B60W 30/0956; G01S 13/865; G01S 13/867; G01S 17/931; G06T 7/292; G06T 7/30; G06V 20/58; B60W 2420/403; B60W 2420/408; B60W 2554/402; B60W 2554/4041; B60W 2754/70

(57) ABSTRACT

An object recognition apparatus includes a LIDAR, a camera, a radar, and a processor. The processor may identify a LIDAR track, identify a fusion track, and generate a synthetic fusion track including at least one of a longitudinal position, a lateral position, a width, a length, or a heading represented by the fusion track and corresponding to the object based on determining that at least one of the following conditions is satisfied: a distribution shape of LIDAR points included in the LIDAR track satisfies a distribution condition, a width of the fusion track satisfies a width condition, a ratio of a width of the LIDAR track to the width of the fusion track satisfies a ratio condition, or class information of the object according to the fusion track satisfies a class condition.

### CROSS-REFERENCE TO RELATED APPLICATION

This application claims the benefit of and priority to Korean Patent Application No. 10-2023-0174674, filed on Dec. 5, 2023, the entire contents of which are hereby incorporated herein by reference.

### TECHNICAL FIELD

The present disclosure relates to an object recognition apparatus and method, and more particularly to a technique for improving the accuracy of information about an object obtained through light detection and ranging (LIDAR) and at least one other sensor.

### BACKGROUND

Technology to detect surrounding environments and avoid obstacles is essential for autonomous vehicles.

A vehicle is able to obtain data indicative of the position of an object around the vehicle through a LIDAR device and at least one other sensor. The vehicle may identify a track corresponding to the object based on information about the object obtained through the LIDAR device and information about the object obtained through the at least one other sensor. The track may include information about the position of the object, and information about the size of the object.

### SUMMARY

The present disclosure has been made to solve the above-mentioned problems occurring in the prior art while advantages achieved by the prior art are maintained intact.

Aspects of the present disclosure provide an object recognition apparatus and method capable of improving the accuracy of the position of an object based on a track obtained through a plurality of sensors, rather than through a single sensor.

Aspects of the present disclosure provide an object recognition apparatus and method capable of improving the accuracy of the position of an object by reducing errors due to exhaust gas.

Aspects of the present disclosure provide an object recognition apparatus and method capable of improving the accuracy of the position of an object by reducing errors due to seasonal and temperature variations.

Aspects of the present disclosure provide an object recognition apparatus and method capable of reducing the risk of occurrence of an accident by improving the accuracy of the position of an object.

Aspects of the present disclosure provide an object recognition apparatus and method capable of improving the convenience of vehicle operation by improving the accuracy of the position of an object

The technical problems to be solved by the present disclosure are not limited to the aforementioned problems. Other technical problems not mentioned herein should be clearly understood from the following description by those having ordinary skill in the art to which the present disclosure pertains.

According to an aspect of the present disclosure, an object recognition apparatus is provided. The object recognition apparatus includes a light detection and ranging (LIDAR) device, a camera, a radar, and a processor. The processor is configured to identify a LIDAR track obtained through the LIDAR device and corresponding to an object outside of a host vehicle. The processor is also configured to identify a fusion track obtained through at least one of the radar or the camera and corresponding to the object. The processor is further configured to generate a synthetic fusion track including at least one of a longitudinal position, a lateral position, a width, a length, or a heading represented by the fusion track and corresponding to the object based on determining that at least one of the following conditions is satisfied: a distribution shape of LIDAR points included in the LIDAR track satisfies a distribution condition, a width of the fusion track satisfies a width condition, a ratio of a width of the LIDAR track to the width of the fusion track satisfies a ratio condition, or class information of the object according to the fusion track satisfies a class condition.

According to an embodiment, the processor may be configured to determine that the distribution shape of the LIDAR points satisfies the distribution condition based on determining that the distribution shape of the LIDAR points included in the LIDAR track is not a specified shape identified as being unaffected by exhaust gas.

According to an embodiment, the processor may be configured to determine that the width of the fusion track satisfies the width condition based on determining that the width of the fusion track falls within a width range specified to distinguish whether the object is an automobile.

According to an embodiment, the processor may be configured to determine that the ratio satisfies the ratio condition based on determining that the ratio of the width of the LIDAR track to the width of the fusion track falls within a ratio range specified to identify whether the LIDAR track is affected by exhaust gas.

According to an embodiment, the processor may be configured to determine that the width of the fusion track satisfies the width condition based on determining that the width of the fusion track is greater than a width value specified to distinguish whether the object is an automobile. The processor may also be configured to determine that the ratio satisfies the ratio condition based on determining that the ratio of the width of the LIDAR track to the width of the fusion track is greater than a ratio value specified to identify whether the LIDAR track is affected by exhaust gas.

According to an embodiment, the processor may be configured to determine that the class information satisfies the class condition based on the class information indicating an automobile. The class information may be indicative of a type of the object according to the fusion track.

According to an embodiment, the processor may be configured to identify the class information based on an image obtained through the camera.

According to an embodiment, the processor may be configured to assign, to the LIDAR track, a flag corresponding to a distribution shape other than an L-shaped shape and an I-shaped shape based on determining that the distribution shape is not the L-shaped shape and is not the I-shaped shape. The processor may also be configured to determine that the distribution shape satisfies the distribution condition based on identifying that the flag corresponding to the LIDAR track is a specified flag indicating a distribution shape corresponding to the distribution shape other than the L-shaped shape and the I-shaped shape.

According to an embodiment, the processor may be configured to determine that the LIDAR points includes LIDAR points caused by exhaust gas emitted from the object based on determining that at least one of the following conditions is satisfied: the distribution shape satisfying the distribution condition, the width satisfying the width condition, the ratio satisfying the ratio condition, or the class information satisfying the class condition. The processor may be configured to generate the synthetic fusion track based on determining that the LIDAR points include the LIDAR points caused by the exhaust gas emitted from the object.

According to an embodiment, the processor may be configured to, when it is determined that i) the object enters a host lane that is a lane where the host vehicle is located based on a heading of the LIDAR track including the LIDAR points caused by exhaust gas emitted from the object and ii) the object does not enter the host lane based on a heading of the fusion track, determine that the object does not enter the host lane.

According to an embodiment, the camera may include a front side view camera configured to obtain an image in front of the host vehicle. The radar may include at least one of a front radar configured to obtain a radar point in front of the host vehicle, a front corner radar configured to obtain a radar point at a front corner of the host vehicle, or a rear corner radar configured to obtain a radar point at a rear corner of the host vehicle. The processor may be configured to obtain the fusion track through at least one of the front side view camera, the front radar, the front corner radar, or the rear corner radar.

According to another aspect of the present disclosure, an object recognition method is provided. The object recognition method includes identifying a LIDAR track obtained through a LIDAR device and corresponding to an object outside of a host vehicle. The object recognition method also includes identifying a fusion track obtained through at least one of a radar or a camera and corresponding to the object. The object recognition method additionally includes generating a synthetic fusion track including at least one of a longitudinal position, a lateral position, a width, a length, or a heading represented by the fusion track and corresponding to the object based on determining that at least one of the following conditions is satisfied: a distribution shape of LIDAR points included in the LIDAR track satisfies a distribution condition, a width of the fusion track satisfies a width condition, a ratio of a width of the LIDAR track to the width of the fusion track satisfies a ratio condition, or class information of the object according to the fusion track satisfies a class condition.

According to an embodiment, generating the synthetic fusion track may include determining that the distribution shape of the LIDAR points satisfies the distribution condition based on determining that the distribution shape of the LIDAR points included in the LIDAR track is not a specified shape identified as being unaffected by exhaust gas.

According to an embodiment, generating the synthetic fusion track may include determining that the width of the fusion track satisfies the width condition based on determining that the width of the fusion track falls within a width range specified to distinguish whether the object is an automobile.

According to an embodiment, generating the synthetic fusion track may include determining that the ratio satisfies the ratio condition based on determining that the ratio of the width of the LIDAR track to the width of the fusion track falls within a ratio range specified to identify whether the LIDAR track is affected by exhaust gas.

According to an embodiment, generating the synthetic fusion track may include determining that the width of the fusion track satisfies the width condition based on determining that the width of the fusion track is greater than a width value specified to distinguish whether the object is an automobile. Generating the synthetic fusion track may also include determining that the ratio satisfies the ratio condition based on determining that the ratio of the width of the LIDAR track to the width of the fusion track is greater than a ratio value specified to identify whether the LIDAR track is affected by exhaust gas.

According to an embodiment, generating the synthetic fusion track may include determining that the class information satisfies the class condition based on determining that the class information indicates an automobile. The class information may be indicative of a type of the object according to the fusion track.

According to an embodiment, generating the synthetic fusion track may include identifying the class information based on an image obtained through the camera.

According to an embodiment, generating the synthetic fusion track may include assigning, to the LIDAR track, a flag corresponding to a distribution shape other than an L-shaped shape and an I-shaped shape based on the distribution shape not being the L-shaped shape and not being the I-shaped shape. Generating the synthetic fusion track may also include determining that the distribution shape satisfies the distribution condition based on identifying that the flag corresponding to the LIDAR track is a specified flag indicating a distribution shape corresponding to the distribution shape other than the L-shaped shape and the I-shaped shape.

According to an embodiment, generating the synthetic fusion track may include determining that the LIDAR points include LIDAR points caused by exhaust gas emitted from the object based on determining that at least one of the distribution shape satisfies the distribution condition, the width satisfies the width condition, the ratio satisfies the ratio condition, or the class information satisfies the class condition. Generating the synthetic fusion track may include generating the synthetic fusion track based on determining that the LIDAR points include the LIDAR points caused by the exhaust gas emitted from the object.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram showing a configuration of an object recognition apparatus, according to an embodiment of the present disclosure;

FIG. 2 illustrates an example of an identified object and a LIDAR track corresponding to the object in a conventional object recognition apparatus or method;

FIG. 3 illustrates an example of an object recognition apparatus, according to an embodiment of the present disclosure;

FIG. 4 illustrates an example of operation of generating a synthetic fusion track in an object recognition apparatus, or an object recognition method, according to embodiments of the present disclosure;

FIG. 5 illustrates an example of a distribution condition for a distribution shape of LIDAR points in an object recognition apparatus, or an object recognition method, according to embodiments of the present disclosure;

FIG. 6 illustrates examples of a width condition related to the width of a fusion track, a ratio condition related to the ratio of the width of a LIDAR track to the width of the fusion track, and a class condition related to class information of an object according to the fusion track, in an object recognition apparatus or an object recognition method according to embodiments of the present disclosure;

FIG. 7 illustrates a flowchart of operation of generating a synthetic fusion track corresponding to an object in an object recognition apparatus or an object recognition method, according to embodiments of the present disclosure;

FIG. 8 illustrates an example of a synthetic fusion track by a conventional object recognition apparatus or an object recognition method, and an example of a synthetic fusion track by an object recognition apparatus or an object recognition method according to embodiments of the present disclosure; and

FIG. 9 illustrates a computing system related to an object recognition apparatus, or an object recognition method, according to embodiments of the present disclosure.

### DETAILED DESCRIPTION

Hereinafter, some embodiments of the present disclosure are described in detail with reference to the exemplary drawings. In adding the reference numerals to the components of each drawing, it should be noted that the identical or equivalent components are designated by the identical numerals even when the components are displayed on different drawings. Further, in describing the embodiment of the present disclosure, a detailed description of well-known features or functions has been omitted in order not to unnecessarily obscure the gist of the present disclosure.

In describing the components of the embodiment of the present disclosure, terms such as first, second, “A”, “B”, (a), (b), and the like may be used. These terms are merely intended to distinguish one component from another component. These terms do not limit the nature, sequence, or order of the constituent components. Unless otherwise defined, all terms used herein, including technical or scientific terms, have the same meanings as those generally understood by those having ordinary skill in the art to which the present disclosure pertains. Such terms as those defined in a generally used dictionary should be interpreted as having meanings equal to the contextual meanings in the relevant field of art, and should not be interpreted as having ideal or excessively formal meanings unless clearly defined as having such in the present disclosure.

In addition, in the present disclosure, the expressions “greater than” or “less than” may be used to indicate whether a specific condition is satisfied or fulfilled, but are used only to indicate examples, and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. In addition, ‘A’ to ‘B’ means at least one of elements from A (including A) to B (including B).

When a component, device, element, or the like of the present disclosure is described as having a purpose or performing an operation, function, or the like, the component, device, or element should be considered herein as being “configured to” meet that purpose or perform that operation or function.

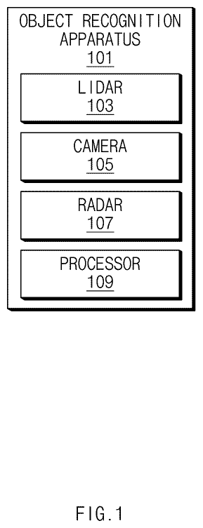

Hereinafter, embodiments of the present disclosure are described in detail with reference to FIGS. 1-9.

FIG. 1 is a block diagram showing a configuration of an object recognition apparatus, according to an embodiment of the present disclosure.

Referring to FIG. 1, an object recognition apparatus 101 may include a light detection and ranging (LIDAR) device 103 (sometimes referred to herein as simply “LADAR”), a camera 105, a radar 107, and a processor 109.

At least one of the LIDAR 103, the camera 105, the radar 107, the processor 109, or any combination thereof may be electrically and/or operatively coupled to each other by an electronic component, such as a communication bus.

According to an embodiment, hereinafter, combining pieces of hardware operatively may mean a direct connection or an indirect connection between the pieces of hardware being established in a wired or wireless manner such that first hardware of the pieces of hardware is controlled by second hardware of the pieces of hardware. The type and/or number of hardware included in the object recognition apparatus 101 is not limited to that shown in FIG. 1. For example, the object recognition apparatus 101 may include only some of hardware components shown in FIG. 1.

According to an embodiment, the processor 109 of the object recognition apparatus 101 may identify an object located outside of a host vehicle based on at least one of the LIDAR 103, the camera 105, the radar 107, or any combination thereof.

For example, the processor 109 of the object recognition apparatus 101 may identify LIDAR points that represent an object outside the host vehicle through the LIDAR device 103. The processor 109 of the object recognition apparatus 101 may identify a LIDAR track that includes the LIDAR points and corresponds to the object.

The processor 109 of the object recognition apparatus 101 may obtain information about the object through the camera 105 and the radar 107. The processor 109 of the object recognition apparatus 101 may identify a fusion track corresponding to the object based on information about the object obtained through the camera 105 and information about the object obtained through the radar 107.

According to an embodiment, the processor 109 of the object recognition apparatus 101 may generate a synthetic fusion track based on information about the LIDAR track and information about the fusion track. For example, the processor 109 of the object recognition apparatus 101 may generate the synthetic fusion track by aggregating information obtained from a plurality of sensors (e.g., the LIDAR 103, the camera 105, and the radar 107).

According to an embodiment, the processor 109 of the object recognition apparatus 101 may identify exhaust gas through the LIDAR 103 when a temperature of ambient air is below a reference value, causing the exhaust gas to condense. The processor 109 of the object recognition apparatus 101 may have difficulty distinguishing between a LIDAR point obtained from the exhaust gas and a LIDAR point obtained from the body of an object that is an automobile. Accordingly, the accuracy of the position, width, length, and heading of the LIDAR track with the influence of exhaust gas may be lower than the accuracy of the position, width, length, and heading of the LIDAR track without the influence of exhaust gas. When the accuracy of the position, width, length, and heading of the track is lower than a reference accuracy, the processor 109 of the object recognition apparatus 101 may incorrectly identify the object as encroaching into a host lane, or incorrectly identify the object as not encroaching into the host lane.

On the other hand, a fusion track obtained through the camera 105 and the radar 107 may be less affected by exhaust gas than a LIDAR track obtained through the LIDAR 103. Accordingly, when a temperature of ambient air is below a reference value, causing exhaust gas to condense, the accuracy of the position, width, length, and heading of the fusion track affected by the ambient air may be higher than the accuracy of the position, width, length, and heading of the LIDAR track affected by the ambient air.

Therefore, the processor 109 of the object recognition apparatus 101 may identify the longitudinal position, lateral position, width, length, and heading represented by the fusion track as the longitudinal position, lateral position, width, length, and heading of the synthetic fusion track when the LIDAR track with the influence of exhaust gas is obtained.

According to an embodiment, the processor 109 of the object recognition apparatus 101 may identify an object as not entering a host lane even when the object is identified as entering the host lane according to the heading of the LIDAR track affected by the exhaust gas, but is not identified as entering the host lane according to the headings of the fusion track.

According to an embodiment, the processor 109 of the object recognition apparatus 101 may determine that the LIDAR points include LIDAR points identified by exhaust gas emitted by an object based on determining that at least one of the distribution shape of the LIDAR points included in the LIDAR track satisfies a distribution condition, the width of the fusion track satisfies a width condition, the ratio of the width of the LIDAR track to the width of the fusion track satisfies a ratio condition, and/or the class information of the object according to the fusion track satisfies a class condition.

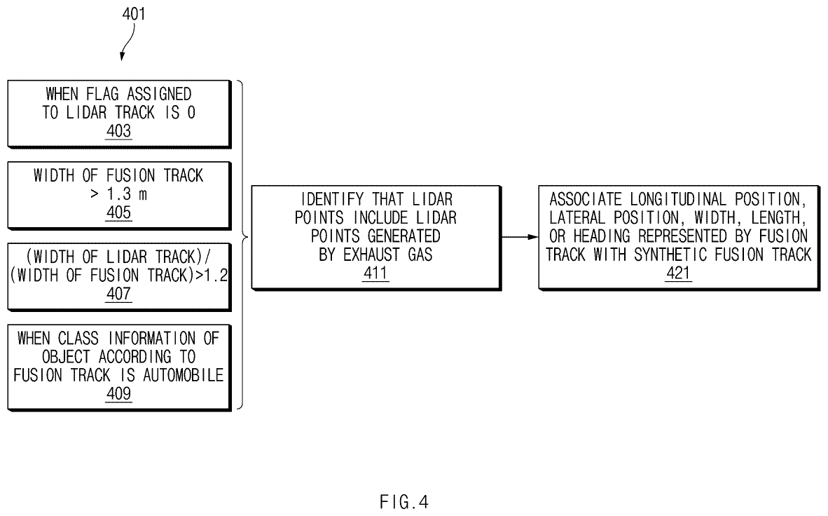

The distribution condition, the width condition, the ratio condition, and the class condition, according to an embodiment, are described in more detain below with reference to FIG. 4.

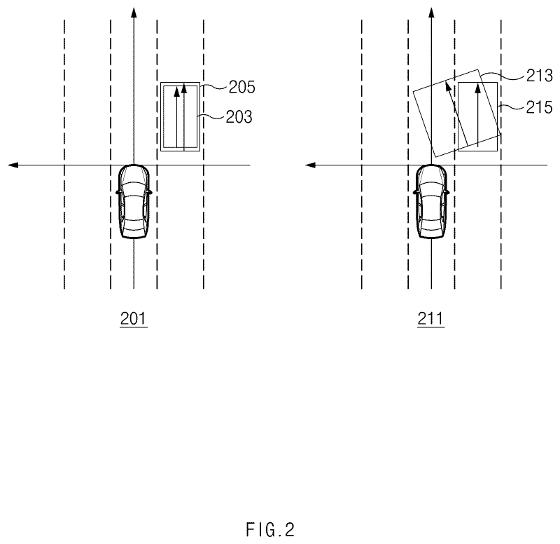

FIG. 2 illustrates an example of an identified object and a LIDAR track corresponding to the object in a conventional object recognition apparatus or method.

Referring to FIG. 2, in a first situation 201, a LIDAR point generated by exhaust gas may not be identified by the conventional object recognition apparatus. In the first situation 201, the conventional object recognition apparatus may display a first object 205 representing an object when there is no influence of exhaust gas, and a first LIDAR track 203 corresponding to the object when there is no influence of exhaust gas and obtained through a LIDAR.

In a second situation 211, the conventional object recognition apparatus may display a second object 215 representing an object when there is influence of exhaust gas, and a second LIDAR track 213 corresponding to the object when there is influence of exhaust gas and obtained through a LIDAR.

In the first situation 201, information (e.g., position, width, length, heading) of the first object 205 may be identical to information (e.g., position, width, length, heading) of the object represented by the first LIDAR track 203.

In the second situation 211, the position of the second object 215 may be different from the position of the object represented by the second LIDAR track 213.

In the second situation 211, the information of the second object 215 may be different from the information of the object represented by the second LIDAR track 213 because the conventional object recognition apparatus identifies the exhaust gas as an object through a LIDAR.

When there is influence of exhaust gas, the processor of an object recognition apparatus according to an embodiment may identify object information obtained from a sensor other than the LIDAR. Hereinafter, the operation of an object recognition apparatus according to an embodiment when there is influence of exhaust gas will be described with reference to FIG. 4.

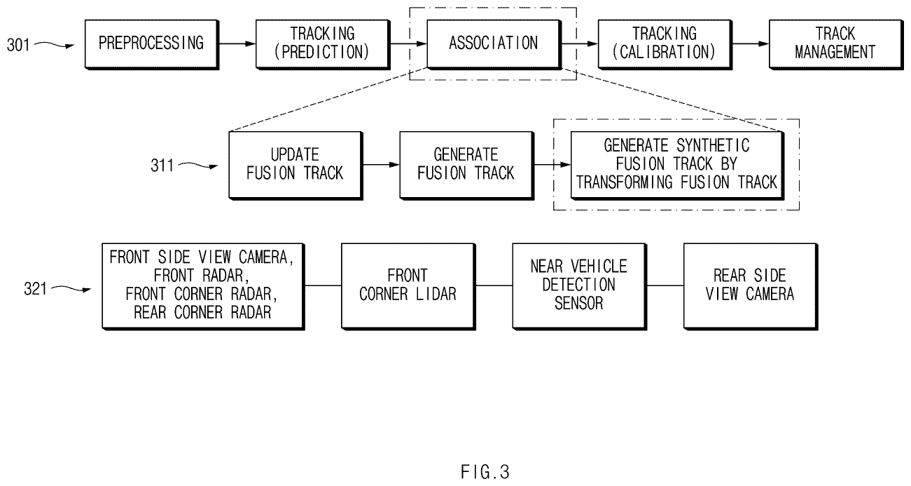

FIG. 3 illustrates an example of an object recognition apparatus according to an embodiment of the present disclosure.

Referring to FIG. 3, an object recognition apparatus 301 may include a preprocessing device, a tracking device that performs prediction and calibration, an association device, and a track management device. An association device 311 may perform an operation of updating a fusion track, an operation of generating a fusion track, and an operation of generating a synthetic fusion track by transforming a fusion track. A set of sensors 321 for generating a synthetic fusion track may include a front side view camera, a front radar, a front corner radar, a rear corner radar, a front corner LIDAR, a near vehicle detection (NVD) sensor, and a rear side view camera (RSIR).

According to an embodiment, the fusion track may be a sensor fusion star (SF*) track, but embodiments of the present disclosure are not limited thereto. According to an embodiment, the synthetic fusion track may be a dynamic object fusion (DOF) track, but embodiments of the present disclosure are not limited thereto. According to an embodiment, the synthetic fusion track may represent a fusion track for a dynamic object identified by a plurality of sensors in Level 3 of autonomous driving or driver assistance device, but embodiments of the present disclosure are not limited thereto.

According to an embodiment, the autonomous driving device or the driver assistance device may perform the autonomous driving or driving by the driver assistance device through a surrounding environment recognition process, a determination process, and a control process. The object recognition apparatus 301 included in a vehicle may perform the surrounding environment recognition process. The surrounding environment recognition process performed by the object recognition apparatus 301 may include preprocessing by the preprocessing device, tracking prediction by the tracking device that performs prediction, operations performed by the association device 311, tracking calibration by the tracking device that; calibration, and track management by the track management device.

The object recognition apparatus 301 may perform validity checks on tracks respectively identified by sensors, using the preprocessing device during the preprocessing process, to select tracks suitable for fusion. In the association process, the object recognition apparatus 301 may identify whether the tracks respectively identified by the sensors represent the same object, using the association device 311. The object recognition apparatus 301 may assign an identifier (ID) to the synthetic fusion track, process the synthetic fusion track, and determine whether to delete the synthetic fusion track, using the track management device.

The association device 311 may perform an operation of updating a fusion track, an operation of generating a fusion track, and an operation of generating a synthetic fusion track by transforming a fusion track, to represent tracks representing the same object as a single synthetic fusion track.

The operation of generating a synthetic fusion track by transforming the fusion track may include an operation of identifying which of a plurality of physical quantity values from a plurality of sensors is to be used to generate the synthetic fusion track.

The object recognition apparatus 301 may identify tracks (e.g., a fusion track and a LIDAR track) for generating the synthetic fusion track from at least one sensor (e.g., front side view camera, front radar, front corner radar, rear corner radar, front corner LIDAR, rear corner LIDAR, near vehicle detection sensor, and/or rear side view camera) included in the set of sensors 321 for generating the synthetic fusion track.

According to an embodiment, the object recognition apparatus 301 may identify a fusion track through at least one of the front side view camera, the front radar, the front corner radar, the rear corner radar, or any combination thereof.

FIG. 4 illustrates an example of operation of identifying a synthetic fusion track in an object recognition apparatus or an object recognition method, according to embodiments of the present disclosure.

Hereinafter, it is assumed that the processor 109 of the object recognition apparatus 101 of FIG. 1 performs the process of FIG. 4. Also, in the description of FIG. 4, the operations described as being performed by the processor of the object recognition apparatus may be understood as being performed by the processor 109 of the object recognition apparatus 101.

Referring to FIG. 4, the processor of the object recognition apparatus may perform an operation 411 based on determining, in an operation 401, that the distribution shape of LIDAR points included in a LIDAR track satisfies a distribution condition 403, the width of a fusion track satisfies a width condition 405, a ratio of the width of the LIDAR track to the width of the fusion track satisfies a ratio condition 407, and class information of an object according to the fusion track satisfies a class condition 409.

According to one embodiment, the processor of the object recognition apparatus may determine that the distribution shape of the LIDAR points included in the LIDAR track satisfies the distribution condition 403 based on identifying that the distribution shape of the LIDAR points included in the track is not a specified shape (e.g., L-shaped, I-shaped) that is identified as being unaffected by exhaust gas.

According to an embodiment, the processor of the object recognition apparatus may assign, to the LIDAR track, a flag corresponding to a distribution shape identified as being affected by exhaust gas, based on determining that the distribution shape of the LIDAR points is not the specified shape.

According to an embodiment, the processor of the object recognition apparatus may determine that the distribution shape satisfies the distribution condition based on identifying that the flag corresponding to the LIDAR track is a specified flag (e.g., 0).

According to an embodiment, the processor of the object recognition apparatus may determine whether the width of the fusion track satisfies the width condition 405 based on determining whether the width of the fusion track is within a width range (e.g., a range exceeding a specified width value) specified to distinguish whether the object is an automobile. This is because the width of a LIDAR track including LIDAR points caused by exhaust gas may be greater than the width of a typical automobile. The specified width value may be determined to take into account sensor instability.

For example, the processor of the object recognition apparatus may determine that the object is a two-wheeled automobile, or an automobile rather than a pedestrian, when the width of the fusion track is greater than about 1.3 m.

According to an embodiment, the processor of the object recognition apparatus may determine whether a ratio of the width of the LIDAR track to the width of the fusion track satisfies the ratio condition 407 based on determining whether the LIDAR track falls within a ratio range specified to identify whether the LIDAR track is affected by exhaust gas (e.g., a range exceeding a specified ratio value). This is because the width of the LIDAR track including LIDAR points affected by the exhaust gas may be greater than the width of the fusion track for the same object as the object corresponding to the LIDAR track.

Because errors caused by a sensor may cause errors in information about the object represented by the fusion track, the processor of the object recognition apparatus may determine whether a condition is satisfied based on the ratio of the width of the LIDAR track to the width of the fusion track, rather than based on a value obtained by subtracting the width of the fusion track from the width of the LIDAR track.

For example, the processor of the object recognition apparatus may determine that the LIDAR track includes LIDAR points caused by the exhaust gas when the ratio of the width of the LIDAR track to the width of the fusion track is greater than about 1.2.

In an example, in a first frame, it may be identified that the width of a LIDAR track is about 1.85 m and the width of a fusion track is about 1.5 m. In a second frame, it may be identified that the width of a LIDAR track is about 1.7 m and the width of a fusion track is about 1.4 m, due to sensor error. When it is determined whether the LIDAR track includes LIDAR points caused by exhaust gas based on the value obtained by subtracting the width of the fusion track from the width of the LIDAR track, the value obtained by the subtraction may be 0.35 m in the first frame and may be 0.3 m in the second frame.

When the processor of the object recognition apparatus determines that the LIDAR track includes LIDAR points caused by exhaust gas in a case where the value obtained by subtracting the width of the fusion track from the width of the LIDAR track is greater than about 0.3 m, the processor of the object recognition apparatus may be able to identify that the LIDAR track is affected by exhaust gas in the first frame, but may be unable to identify that the LIDAR track is affected by exhaust gas in the second frame.

On the other hand, when the processor of the object recognition apparatus determines that the LIDAR track includes LIDAR points caused by exhaust gas in a case where the ratio of the width of the LIDAR track to the width of the fusion track is greater than 1.2, the processor of the object recognition apparatus may identify that the LIDAR track is affected by exhaust gas in both the first frame and the second frame.

According to an embodiment, the class information indicative of the type of an object according to the fusion track satisfying the class condition 409 may be identified based on the class information indicating an automobile. A processor of the object recognition apparatus may identify the class information based on an image obtained through the camera. The accuracy of the class information identified through the LIDAR may be lower than the accuracy of the class information of the fusion track identified through the camera. According to an embodiment, the class information indicating the automobile may include, but is not limited to, 1 indicating a general automobile, 2 indicating a passing automobile, and 3 indicating a commercial automobile such as a truck.

In the operation 411, the processor of the object recognition apparatus may determine that LIDAR points include LIDAR points caused by exhaust gas emitted from the object.

In an operation 421, the processor of the object recognition apparatus may associate a longitudinal position, a lateral position, a width, a length, and a heading represented by a fusion track with a synthetic fusion track.

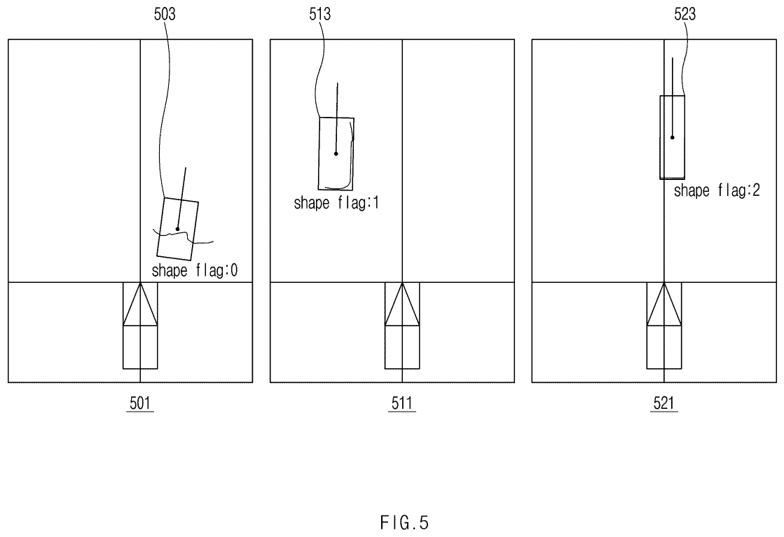

FIG. 5 illustrates an example of a distribution condition for a distribution shape of LIDAR points in an object recognition apparatus or an object recognition method, according to embodiments of the present disclosure.

Referring to FIG. 5, a first LIDAR track 503 included in a first view 501 may be assigned a flag (e.g., shape flag, 0) indicating a distribution shape corresponding to a distribution shape other than an L-shaped shape and an I-shaped shape. A second LIDAR track 513 included in a second view 511 may be assigned a flag (e.g., a shape flag of 1) indicating a distribution shape corresponding to the L-shaped shape. A third LIDAR track 523 included in a third view 521 may be assigned a flag (e.g., a shape flag of 2) indicating a distribution shape corresponding to the I-shaped shape.

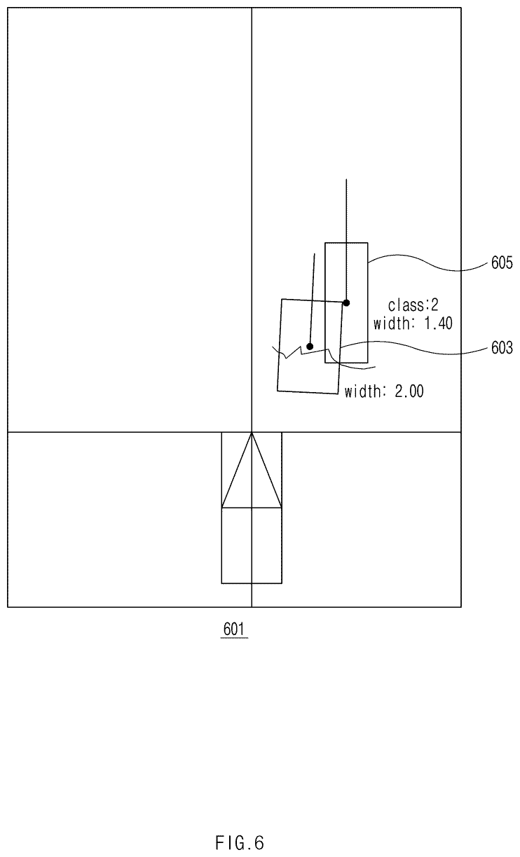

FIG. 6 illustrates examples of a width condition related to the width of a fusion track, a ratio condition related to the ratio of the width of a LIDAR track to the width of the fusion track, and a class condition related to class information of an object according to the fusion track, in an object recognition apparatus or an object recognition method, according to embodiments of the present disclosure.

Referring to FIG. 6, a view 601 may include a LIDAR track 603 and a fusion track 605. The width of the LIDAR track 603 may be identified as being about 2.00 m. The width of fusion track 605 may be identified as being about 1.40 m. A class of an object according to the fusion track 605 (e.g., 2) may indicate an automobile.

According to an embodiment, because the distribution shape of LIDAR points included in the LIDAR track 603 is identified as being influenced by exhaust gas, the distribution condition may be satisfied.

According to an embodiment, the width condition may be satisfied based on the width of the fusion track (e.g., about 1.4 m) falling within a width range (e.g., greater than about 1.3 m) specified to distinguish whether the object is an automobile.

According to an embodiment, the ratio condition may be satisfied based on the ratio of the width of the LIDAR track to the width of the fusion track (e.g., about 1.43) falling within a specified ratio range (e.g., greater than about 1.2).

According to an embodiment, the class condition may be satisfied based on the class information of the fusion track (e.g., 2) indicating an automobile.

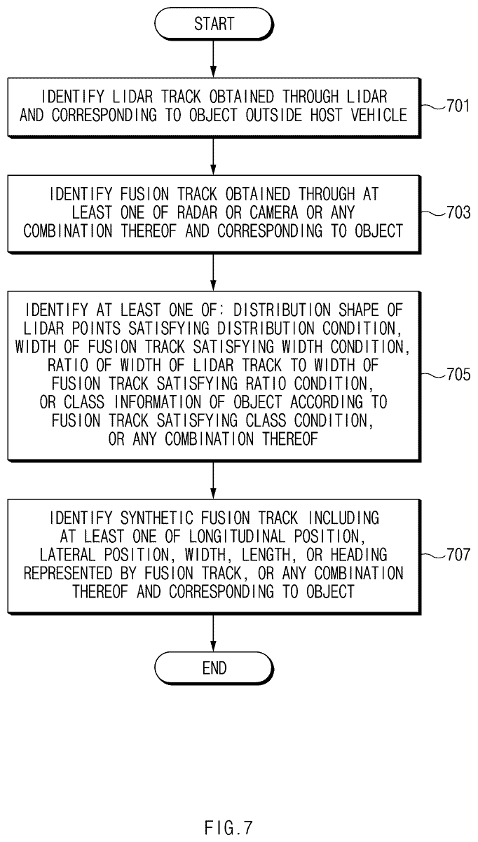

FIG. 7 illustrates a flowchart of operation of generating a synthetic fusion track corresponding to an object in an object recognition apparatus or an object recognition method, according to embodiments of the present disclosure.

Hereinafter, it is assumed that the processor 109 of the object recognition apparatus 101 of FIG. 1 performs the process of FIG. 7. Also, in the description of FIG. 7, the operations described as being performed by the processor of the object recognition apparatus may be understood as being performed by the processor 109 of the object recognition apparatus 101.

Referring to FIG. 7, in an operation 701, the processor of the object recognition apparatus according to an embodiment may identify a LIDAR track obtained through a LIDAR and corresponding to an object outside a host vehicle.

In an operation 703, the processor of the object recognition apparatus according to an embodiment may identify a fusion track obtained through at least one of a radar, a camera, or any combination thereof, and corresponding to the object.

In an operation 705, the processor of the object recognition apparatus according to an embodiment may determine that at least one of a distribution shape of LIDAR points satisfies a distribution condition, the width of a fusion track satisfies a width condition, a ratio of the width of a LIDAR track to the width of the fusion track satisfies a ratio condition, class information of the object according to the fusion track satisfies a class condition, or any combination thereof.

In an operation 707, the processor of the object recognition apparatus according to an embodiment may generate a synthetic fusion track including at least one of a longitudinal position, a lateral position, a width, a length, a heading represented by the fusion track, or any combination thereof, and corresponding to an object.

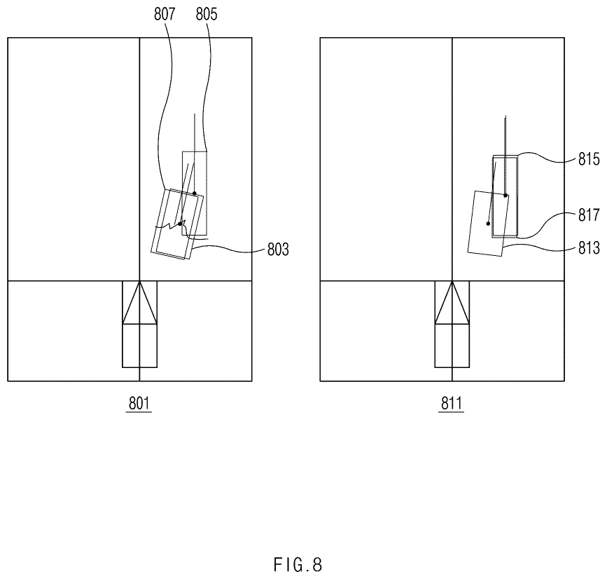

FIG. 8 illustrates an example of a synthetic fusion track by a conventional object recognition apparatus or an object recognition method, and an example of a synthetic fusion track by an object recognition apparatus or an object recognition method according to embodiments.

Referring to FIG. 8, a first view 801 may include a first LIDAR track 803 obtained through a LIDAR, a first fusion track 805 obtained through a radar and a camera, and a first synthetic fusion track 807 identified through the first LIDAR track 803 and the first fusion track 805.

A second view 811 may include a second LIDAR track 813 obtained through the LIDAR, a second fusion track 815 obtained through the radar and the camera, and a second synthetic fusion track 817 identified through the second LIDAR track 813 and the second fusion track 815.

In the first view 801 of a conventional object recognition apparatus, the longitudinal position, the lateral position, the width, the length, and the heading of the first LIDAR track 803 may be different from the longitudinal position, the lateral position, the width, the length, and the heading of the first fusion track 805 due to the influence of exhaust gas. When there is influence of exhaust gas, the accuracy of the longitudinal position, the lateral position, the width, the length, and the heading of the first LIDAR track 803 may be lower than the accuracy of the longitudinal position, the lateral position, the width, the length, and the heading of the first fusion track 805.

The first synthetic fusion track 807 may include information about an object included in the first LIDAR track 803. Accordingly, the accuracy of the longitudinal position, the lateral position, the width, the length, and the heading of the first synthetic fusion track 807 may be lower than the accuracy of the longitudinal position, the lateral position, the width, the length, and the heading of the first fusion track 805.

In the second view 811 of the object recognition apparatus according to an embodiment, the longitudinal position, the lateral position, the width, the length, and the heading of the second LIDAR track 813 may be affected by exhaust gas and may be different from the longitudinal position, the lateral position, the width, the length, and the heading of the second fusion track 815. When there is influence of exhaust gas, the accuracy of the longitudinal position, the lateral position, the width, the length, and the heading of the second LIDAR track 813 may be lower than the accuracy of the longitudinal position, the lateral position, the width, the length, and the heading of the second fusion track 815.

The second synthetic fusion track 817 may represent information about an object included in the second fusion track 815. Accordingly, the accuracy of the longitudinal position, the lateral position, the width, the length, and the heading of the second synthetic fusion track 817 may be higher than the accuracy the longitudinal position, the lateral position, the width, the length, and the heading of the first fusion track 805.

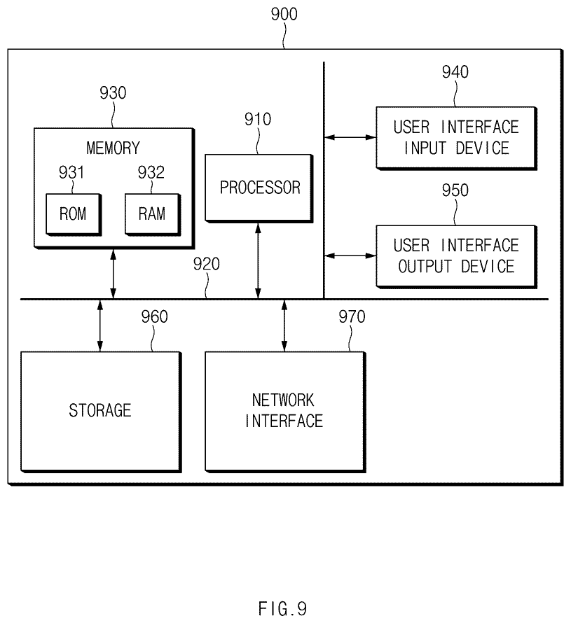

FIG. 9 illustrates a computing system related to an object recognition apparatus or an object recognition method, according to an embodiment of the present disclosure.

Referring to FIG. 9, a computing system 900 may include at least one processor 910, a memory 930, a user interface input device 940, a user interface output device 950, storage 960, and a network interface 970, which are connected with each other through a bus 920.

The processor 910 may be a central processing unit (CPU) or a semiconductor device that executes instructions stored in the memory 930 and/or the storage 960. The memory 930 and the storage 960 may include various types of volatile or non-volatile storage media. For example, the memory 930 may include a ROM (Read Only Memory) 931 and a RAM (Random Access Memory) 932.

Thus, the operations of the method or the algorithm described in connection with the embodiments disclosed herein may be embodied directly in hardware or a software module executed by the processor 910, or in a combination thereof. The software module may reside on a storage medium (e.g., the memory 930 and/or the storage 960) such as a RAM, a flash memory, a ROM, an EPROM, an EEPROM, a register, a hard disk, a removable disk, and a CD-ROM.

The storage medium may be coupled to the processor 910, and the processor 910 may read information out of the storage medium and may record information in the storage medium. Alternatively, the storage medium may be integrated with the processor 910. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those having ordinary skill in the art to which the present disclosure pertains.

Accordingly, the embodiments disclosed in the present disclosure are not intended to limit the technical idea of the present disclosure but to describe the present disclosure. The scope of the technical idea of the present disclosure is not limited by the described embodiments. The scope of protection of the present disclosure should be interpreted by the appended claims, and all technical ideas within the scope equivalent thereto should be construed as being included in the scope of the present disclosure.

Embodiments of the present disclosure may improve the accuracy of the position of an object based on a track obtained through a plurality of sensors.

Embodiments of the present disclosure may improve the accuracy of the position of an object by reducing errors due to exhaust gas.

Embodiments of the present disclosure may improve the accuracy of the position of an object by reducing errors due to seasonal and temperature variations.

Embodiments of the present disclosure may reduce the risk of occurrence of an accident by improving the accuracy of the position of an object.

Embodiments of the present disclosure may improve the convenience of vehicle operation by improving the accuracy of the position of an object.

In addition, various effects may be provided that are directly or indirectly understood through the disclosure.

Hereinabove, although the present disclosure has been described with: reference to certain embodiments and the accompanying drawings, the present disclosure is not limited thereto, but may be variously modified and altered by those having ordinary skill in the art to which the present disclosure pertains without departing from the spirit and scope of the present disclosure claimed in the appended claims.

What is claimed is:

1. An object recognition apparatus comprising:
a light detection and ranging (LIDAR) device;
a camera;
a radar; and
a processor,
wherein the processor is configured to:
identify a LIDAR track obtained through the LIDAR device and corresponding to an object outside of a host vehicle;
identify a fusion track obtained through at least one of the radar or the camera and corresponding to the object; and
generate a synthetic fusion track including at least one of a longitudinal position, a lateral position, a width, a length, or a heading represented by the fusion track and corresponding to the object based on determining that at least one of the following conditions is satisfied:
a distribution shape of LIDAR points included in the LIDAR track satisfies a distribution condition,
a width of the fusion track satisfies a width condition,
a ratio of a width of the LIDAR track to the width of the fusion track satisfies a ratio condition, or
class information of the object according to the fusion track satisfies a class condition.

2. The object recognition apparatus of claim 1, wherein the processor is configured to determine that the distribution shape of the LIDAR points satisfies the distribution condition based on determining that the distribution shape of the LIDAR points included in the LIDAR track is not a specified shape identified as being unaffected by exhaust gas.

3. The object recognition apparatus of claim 1, wherein the processor is configured to determine that the width of the fusion track satisfies the width condition based on determining that the width of the fusion track falls within a width range specified to distinguish whether the object is an automobile.

4. The object recognition apparatus of claim 1, wherein the processor is configured to determine that the ratio satisfies the ratio condition based on determining that the ratio of the width of the LIDAR track to the width of the fusion track falls within a ratio range specified to identify whether the LIDAR track is affected by exhaust gas.

5. The object recognition apparatus of claim 1, wherein the processor is configured to:
determine that the width of the fusion track satisfies the width condition based on determining that the width of the fusion track is greater than a width value specified to distinguish whether the object is an automobile; and
determine that the ratio satisfies the ratio condition based on determining that the ratio of the width of the LIDAR track to the width of the fusion track is greater than a ratio value specified to identify whether the LIDAR track is affected by exhaust gas.

6. The object recognition apparatus of claim 1, wherein the processor is configured to determine that the class information satisfies the class condition based on determining that the class information indicates an automobile, wherein the class information is indicative of a type of the object according to the fusion track.

7. The object recognition apparatus of claim 1, wherein the processor is configured to identify the class information based on an image obtained through the camera.

8. The object recognition apparatus of claim 1, wherein the processor is configured to:
assign, to the LIDAR track, a flag corresponding to a distribution shape other than an L-shaped shape or an I-shaped shape based on determining that the distribution shape is not the L-shaped shape and is not the I-shaped shape; and
determine that the distribution shape satisfies the distribution condition based on identifying that the flag corresponding to the LIDAR track is a specified flag indicating a distribution shape corresponding to the distribution shape other than the L-shaped shape and the I-shaped shape.

9. The object recognition apparatus of claim 1, wherein the processor is configured to:
determine that the LIDAR points include LIDAR points caused by exhaust gas emitted from the object based on determining that at least one of the following conditions is satisfied:
the distribution shape satisfies the distribution condition,
the at least one of width satisfies the width condition, the ratio satisfies the ratio condition, or
the class information satisfies the class condition; and
generate the synthetic fusion track based on determining that the LIDAR points include the LIDAR points caused by the exhaust gas emitted from the object.

10. The object recognition apparatus of claim 9, wherein the processor is configured to, when it is identified that i) the object enters a host lane where the host vehicle is located based on a heading of the LIDAR track including the LIDAR points caused by exhaust gas emitted from the object and ii) the object does not enter the host lane based on a heading of the fusion track, identify that the object does not enter the host lane.

11. The object recognition apparatus of claim 1, wherein:
the camera includes a front side view camera configured to obtain an image in front of the host vehicle;
the radar includes at least one of a front radar configured to obtain a radar point in front of the host vehicle, a front corner radar configured to obtain a radar point at a front corner of the host vehicle, or a rear corner radar configured to obtain a radar point at a rear corner of the host vehicle; and
the processor is configured to obtain the fusion track through at least one of the front side view camera, the front radar, the front corner radar, or the rear corner radar.

12. An object recognition method comprising:
identifying a LIDAR track obtained through a LIDAR device and corresponding to an object outside of a host vehicle;
identifying a fusion track obtained through at least one of a radar or a camera and corresponding to the object; and
generating a synthetic fusion track including at least one of a longitudinal position, a lateral position, a width, a length, or a heading represented by the fusion track and corresponding to the object based on determining that at least one of the following conditions is satisfied:
a distribution shape of LIDAR points included in the LIDAR track satisfies a distribution condition,
a width of the fusion track satisfies a width condition,
a ratio of a width of the LIDAR track to the width of the fusion track satisfies a ratio condition, or
class information of the object according to the fusion track satisfies a class condition.

13. The object recognition method of claim 12, wherein generating the synthetic fusion track includes determining that the distribution shape of the LIDAR points satisfies the distribution condition based on determining that the distribution shape of the LIDAR points included in the LIDAR track is not a specified shape identified as being unaffected by exhaust gas.

14. The object recognition method of claim 12, wherein generating the synthetic fusion track includes determining that the width of the fusion track satisfies the width condition based on determining that the width of the fusion track falls within a width range specified to distinguish whether the object is an automobile.

15. The object recognition method of claim 12, wherein generating the synthetic fusion track includes determining that the ratio satisfies the ratio condition based on determining that the ratio of the width of the LIDAR track to the width of the fusion track falls within a ratio range specified to identify whether the LIDAR track is affected by exhaust gas.

16. The object recognition method of claim 12, wherein generating the synthetic fusion track includes:
determining that the width of the fusion track satisfies the width condition based on determining that the width of the fusion track is greater than a width value specified to distinguish whether the object is an automobile; and
determining that the ratio satisfies the ratio condition based on determining that the ratio of the width of the LIDAR track to the width of the fusion track is greater than a ratio value specified to identify whether the LIDAR track is affected by exhaust gas.

17. The object recognition method of claim 12, wherein generating the synthetic fusion track includes determining that the class information satisfies the class condition based on determining that the class information indicates an automobile, wherein the class information is indicative of a type of the object according to the fusion track.

18. The object recognition method of claim 12, wherein generating the synthetic fusion track includes identifying the class information based on an image obtained through the camera.

19. The object recognition method of claim 12, wherein generating the synthetic fusion track includes:
assigning, to the LIDAR track, a flag corresponding to a distribution shape other than an L-shaped shape and an I-shaped shape based on determining that the distribution shape is not the L-shaped shape and is not the I-shaped shape; and
determining that the distribution shape satisfies the distribution condition based on identifying that the flag corresponding to the LIDAR track is a specified flag indicating a distribution shape corresponding to the distribution shape other than the L-shaped shape and the I-shaped shape.

20. The object recognition method of claim 12, wherein generating the synthetic fusion track includes:
determining that the LIDAR points includes LIDAR points caused by exhaust gas emitted from the object based on determining that at least one of the distribution shape satisfies the distribution condition, the width satisfies the width condition, the ratio satisfies the ratio condition, or the class information satisfies the class condition; and
generating the synthetic fusion track based on determining that the LIDAR points include the LIDAR points caused by the exhaust gas emitted from the object.
